(19) United States
(12) Patent Application Publication
(10) Pub. No.: US 2015/0278556 A1
(43) Pub. Date: Oct. 1, 2015

(54) CENTRALIZED SECURITY FOR A COMPUTING DEVICE

(71) Applicants: Noam Avni, Mevaseret Zion (IL); Itamar Levin, Holon (IL)

(72) Inventors: Noam Avni, Mevaseret Zion (IL); Itamar Levin, Holon (IL)

(21) Appl. No.: 14/229,274

(22) Filed: Mar. 28, 2014

(51) Int. Cl. G06F 21/81; G06F 3/0481; G06F 21/31

(52) U.S. Cl. CPC G06F 21/81; G06F 21/31; G06F 3/0481

(57) ABSTRACT

A security procedure may be triggered in response to a detected activation event to release a lock securing a computing device, initiate the security procedure responsive to the activation event, enable a secure computing mode on the computing device, request authentication data, verify the authentication data and send a command to release the lock responsive to verification of the authentication data.

### TECHNICAL FIELD

Examples described herein generally relate to methods, systems, and devices to provide a secure locking system for a mobile communications device, mobile computing or communications device.

### BACKGROUND

Currently, computer hardware comes with many ways of ensuring software and data security, but the solutions available for prevention of physical theft of the device (and loss of the data stored on it) are crude and limited.

### BRIEF DESCRIPTION OF THE DRAWINGS

The various advantages of the embodiments will become apparent to one skilled in the art by reading the following specification and appended claims, and by referencing the following drawings, in which:

FIG. 1A illustrates an example of a system configured to secure and/or release a lock on a computing device.

FIG. 1B illustrates an example of a system configured to secure and/or release a lock on a computing device.

FIG. 1C illustrates an example of a system configured to secure and/or release a lock on a computing device.

FIG. 1D illustrates an example of a lock to secure a computing device.

FIG. 1E is a cutaway view of an example of a lock to secure a computing device.

FIG. 1F is an isometric view of an example of a lock to secure a computing device.

FIG. 1G is a cutaway view of an example of a lock to secure a computing device.

FIG. 1H is a cutaway view of an example of a lock to secure a computing device.

FIG. 2A is a block diagram illustrating an example of a system configured to secure and/or release a lock on a computing device.

FIG. 2B is a functional diagram illustrating an example of system configured to secure and/or release a lock configured to secure a computing device.

FIG. 3 illustrates an example process for a security controller to generate and store authentication data to secure a computing device.

FIG. 4 illustrates an example process to secure and/or release a lock on a computing device.

FIG. 5 illustrates an example process to secure a lock on a computing device.

FIG. 6A illustrates an example of a system to remotely secure and/or release a lock on a computing device.

FIG. 6B illustrates an example of a process to remotely secure and/or release a lock a computing device.

### DETAILED DESCRIPTION

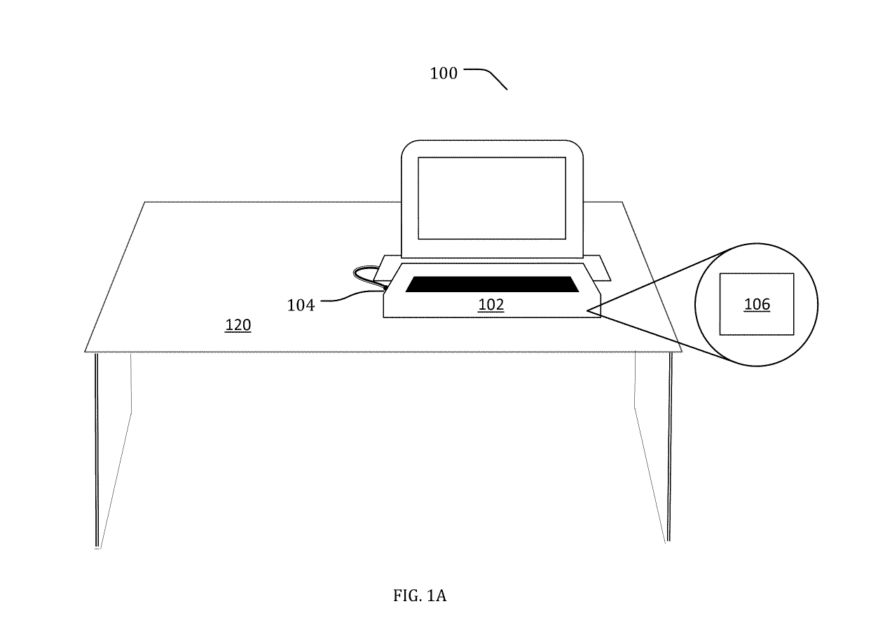

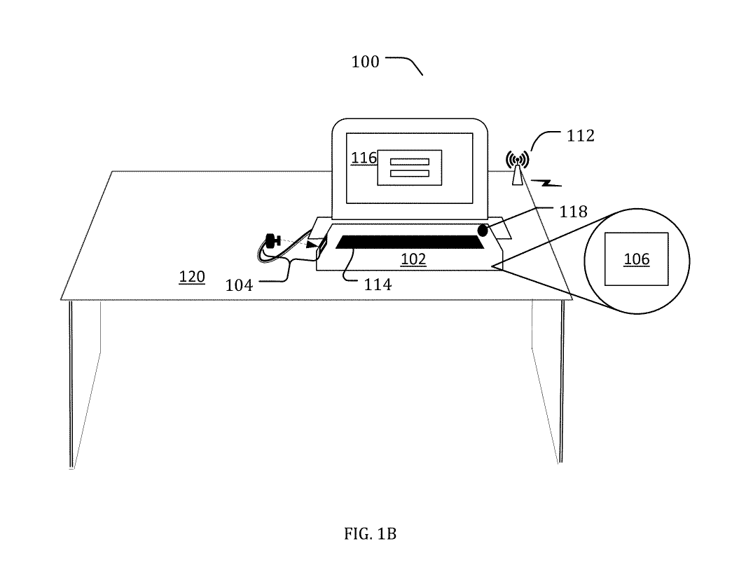

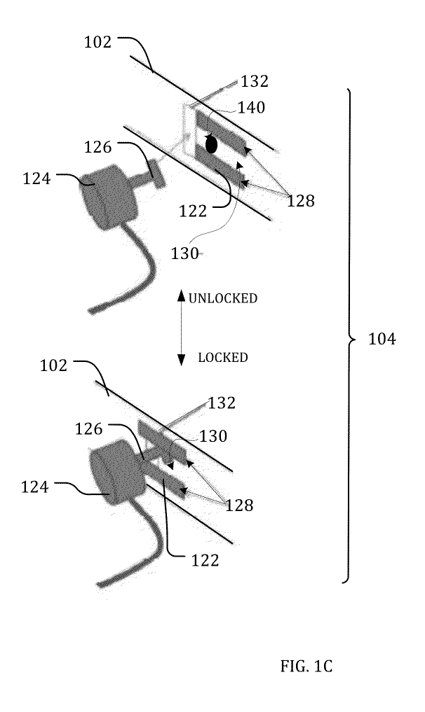

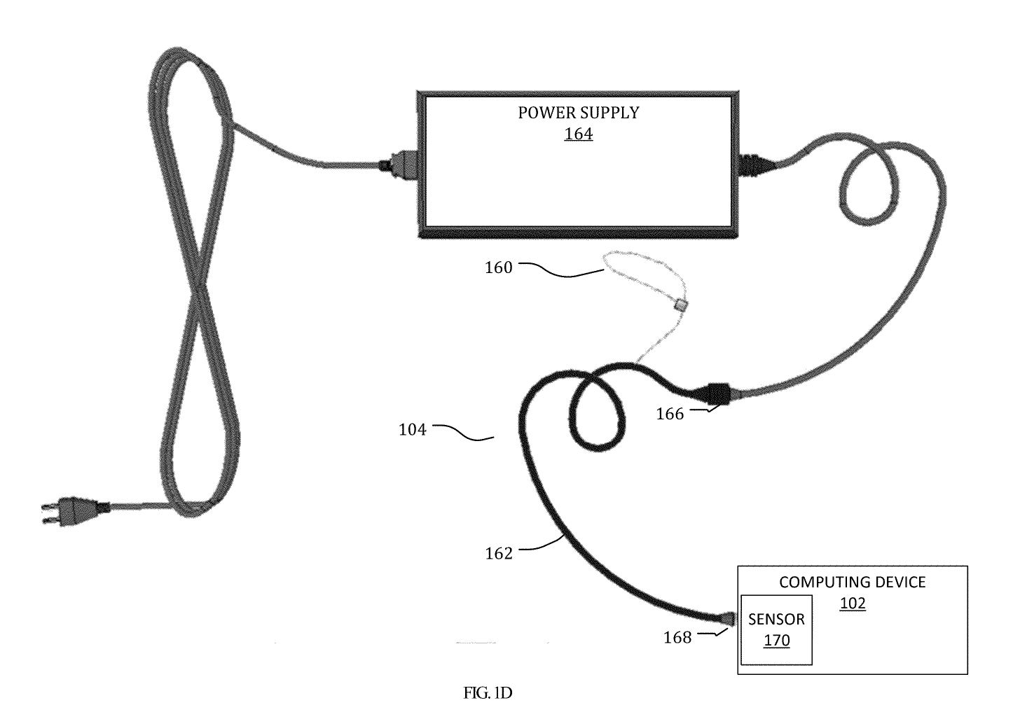

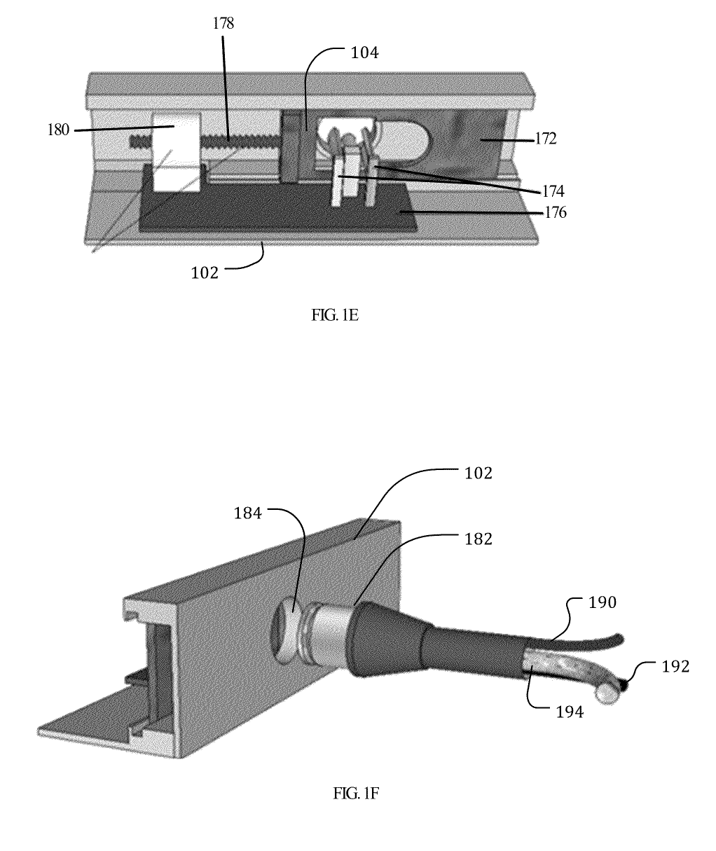

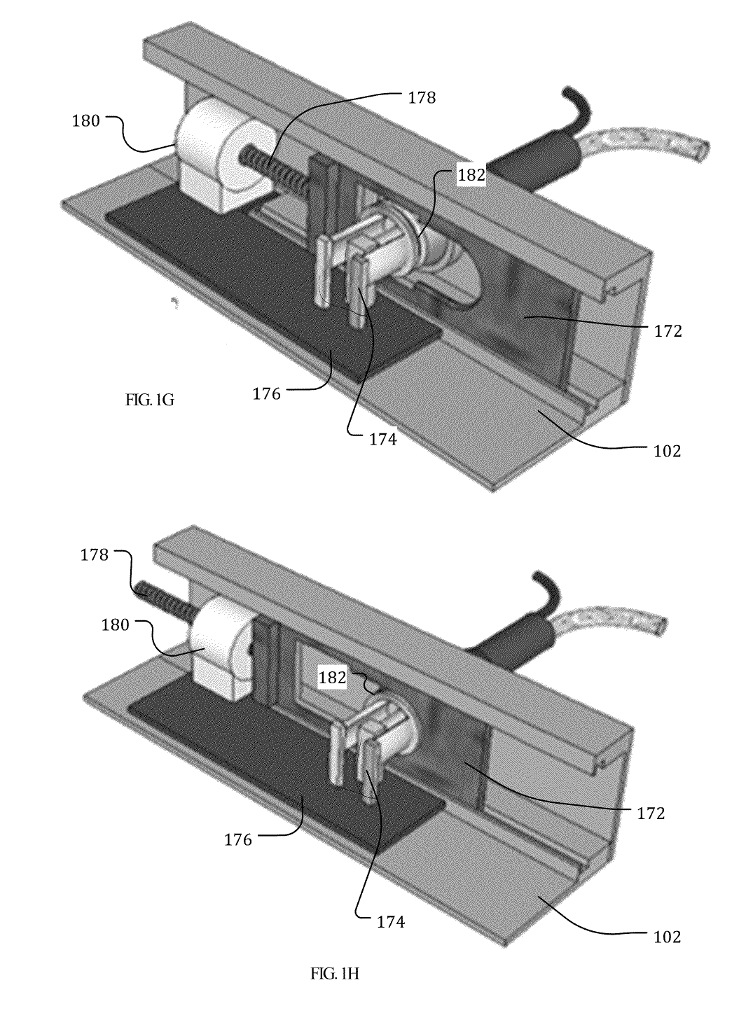

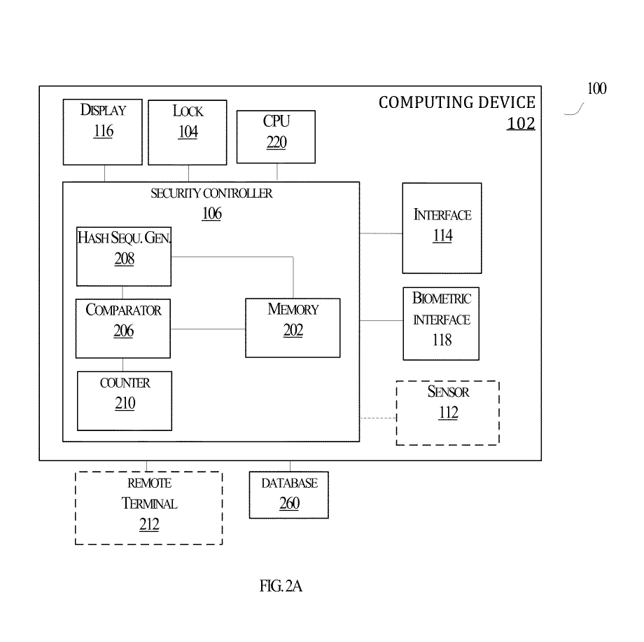

In the following description the term “computing device” should be understood to refer to a mobile or stationary computing device and/or a mobile or stationary communication device. FIG. 1A illustrates an example of a system 100 for securing and releasing a computing device 102. Computing device 102 may comprise a stationary computing device such as a desktop computer or a mobile device such as a laptop computer, a tablet, a mobile phone, an Ultrabook® system, a wearable computer and/or the like or a combination thereof. Computing device 102 may comprise lock 104. Lock 104 may be configured to secure computing device 102, for example to a desk 120. Computing device 102 may comprise a security controller 106 which may be configured to manage one or more security procedures on computing device 102 and may be configured to electronically control lock 104. Security controller 106 may be implemented in software and/or hardware in computing device 102. Security controller 106 may be instantiated in computing device 102 as a processor in a System on a Chip (SoC), a Platform Controller Hub (PCH), as a separate integrated circuit (IC) and/or as a separate board device, or the like or a combination thereof. In an example, security controller 106 may form a part of a power management micro-processor/software system within a PCH. Alternatively, security controller 106 may be implemented in a main microprocessor of a SoC. Implementing security controller 106 in a SoC or a PCH may enable security controller 106 to directly and securely access various security features of the SoC and/or PCH such as an encryption engine and/or the Central Processing Unit Identification (CPUID).

FIG. 1B illustrates an example of a system 100 for securing and releasing a computing device 102. In an example, lock 104 may comprise a physical lock. Lock 104 may be configured to be electronically controlled by security controller 106. An electronically controlled lock 104 may comprise a solenoid, a magnetic lock, a magnetic adhesion device, a rotary based lock and/or the like or a combination thereof. Lock 104 may comprise a first portion 122 including a slot 130 configured to mate to a second portion 124 of lock 104. First portion 122 may be integrated with computing device 102. Second portion 124 may be coupled to an object such as desk 120. In an example second portion 124 may be a locking cable/chain and may be coupled to a table, a wall and/or the like or a combination thereof. Lock 104 when secured may anchor computing device 102 to an object such as desk 120, a wall, the ground and/or a post, or the like or a combination thereof.

In an example, lock 104 may be a virtual lock configured to be activated and/or deactivated responsive to the presences and/or absence of computing device 102 within a particular area. Such a virtual lock when in a locked mode may disable some or substantially all functionality of computing device 102 and when in an unlocked mode may permit some or substantially all functionality of computing device 102. Sensor 112 may be configured to sense when computing device 102 is within a particular distance of sensor 112 and may send a signal to security controller 106 indicating the presences or absence of computing device 102 in the particular area. Security controller 106 may initiate the security procedure based on the presence or absence of computing device 102 in the particular area and may activate and/or deactivate lock 104 based on the successful or unsuccessful completion of the security procedure. Computing device 102 may be configured to send out a wireless signal that may be detected by sensor 112 within a known range defining the particular area. The wireless signal may be a Radio Frequency Identification (RFID) signal, Wi-Fi signal, Bluetooth signal, Zigbee signal, a new signal designed specifically for this purpose or any new wireless interface in general that may come into existence in the future and/or the like or a combination thereof. Sensor 112 may comprise any of a variety of proximity sensors configured to sense a variety of wireless signals such as such as RFID, Wi-FI, Bluetooth, Zigbee and/or the like or a combination thereof.

In an example, a security procedure may be initiated by security controller 106 responsive to an activation event associated with the computing device 102. An activation event may be detected by security controller 106 and may trigger activation of the security procedure. An activation event may comprise an authentication request or success or failure thereof, powering on computing device 102, a request for secure access to the computing device, sensing an attempt to release lock 104, a unique button press, a key press, a key combination, wireless sensor 112 detecting the computing device within a particular area, and/or the or a combination thereof.

In an example, the security procedure may authenticate a user who may enter authentication data via interface 114 and or a biometric interface 118 on computing device 102. Security controller 106 may be configured to request the authentication data, for example, via a Graphical User Interface (GUI) displayed on display 116. Security controller 106 may receive and/or detect any of a variety of authentication data input responsive to the request to execute of the security procedure. Such authentication data may include text data entered via interface 114 and/or biometric data entered via biometric interface 118, or the like or a combination thereof. Interface 114 may be a secure keyboard, secure touch screen, secure touch pad and/or a secure keypad, or the like or a combination thereof.

In an example, security controller 106 may be configured to trigger unlocking of lock 104 and/or disabling of anti-tamper hardware/software upon successful completion of the security procedure. Anti-tamper hardware/software may comprises any of a variety of methods, processes, and/or apparatuses for prevention of tampering with a device such as, for example computing device 102. Anti-tamper hardware/software may be configured to sense tampering and trigger preventative actions such as triggering alarms, alerting administrators or authorities, disabling computing device 102 and/or otherwise cutting off access to computing device 102, and the like or a combination thereof. Some examples of anti-tamper sensing may include, sensing of a screw being unscrewed by transmitting light through the screw's shaft and detecting it from across the shaft, identification of acceleration data associated with a pattern of hard pulls indicating tampering, sensing light within a device, where in normal conditions a cover is on and light is substantially blocked, sensing a threshold number of attempts on a password, identifying attempts at illegal access to a device, toying with a power supply to computing device 102, raising, lowering, cutting of the power flow, or the like or a combination thereof.

In an example, security controller 106 may be configured to trigger an enhanced security measure upon detection of a predetermined number of unsuccessful attempts to execute the security procedure. Such an enhanced security measure may include activating an alarm, disabling computing device 102, activating anti-tamper hardware/software, and/or the like or a combination thereof.

FIG. 1C illustrates an example of lock 104 on computing device 102 in a locked and unlocked position. Lock 104 may be configured to be electronically activated by security controller 106 responsive to one or more commands from security controller 106. Sensor 140 may detect contact, mating and/or coupling of first portion 122 and second portion 124, solenoid controlled deadbolt 128 may be configured to secure lock 104 by moving locking dock 132 into a locked position around a T-bar 126 when T-bar 126 is disposed within slot 130. Security controller 106 may be configured to control movement of locking dock 132 into the locked position around T-bar 126 via an electronic signal. Solenoid controlled deadbolt 128 may be configured to release lock 104 by moving locking dock 132 into an unlocked position. Security controller 106 may be configured to control movement of locking dock 132 into the unlocked position via an electronic signal. In an example, lock 104 may comprise a variety of other physical lock types, such as, a desk mounted security anchor system, a locking dock system, a cam lock and/or the like or a combination thereof.

FIG. 1D illustrates an example of lock 104 to secure computing device 102. In an example, lock 104 comprises an embedded locking wire 160. Lock 104 may comprise locking wire 160 embedded within an extension cord 162. Extension cord 162 may be configured to mate at a first end 166 with a power supply 164 on a side of power supply 164 that is configured to couple to computing device 102. Extension cord 162 may be configured to mate at a second end 168 to computing device 102.

In an example, a sensor 170 in computing device 102 may detect contact, mating and/or coupling of extension cord 162 with computing device 102, with power supply 164 and/or a presence of power and/or the like or a combination thereof.

FIG. 1E is a cutaway view of an example of lock 104 on computing device 102 in an unmated and unlocked position. In this example, lock 104 may comprise a sliding lock blade 172, power terminals 174, a printed circuit board 176, locking blade rotating screw 178 and micro motor 180.

FIG. 1F is an isometric view of an example of lock 104 on computing device 102 in an unmated and unlocked position. Plug 182 may be configured to be inserted into socket 184. Electrical wires 190 and 192 may be placed in communication with respective power terminals 174, for example when plug 182 is disposed within socket 184 in computing device 102. Metal security cable 194 may be coupled to plug 182 and may be configured to secure computing device 102. In an example, metal security cable 194 may be added to power cables under the same overall bonding plastic/PVC wrapping so that is appears to be a single cable.

FIG. 1G is a cutaway view of an example of lock 104 wherein plug 182 is disposed within socket 184 and mated to power terminals 174. Sliding locking blade is in an unlocked position. When plug 182 is mated to power terminals 174, electrical contact may be made. Security controller 106 may detect such electrical contact indicating mating and/or coupling of plug 182 to power terminals 174 via PCB 176. Micro motor 180 may be configured to be electronically activated by security controller 106 responsive to one or more commands from security controller 106 responsive to detection of the mated of plug 182 to power terminals 174. Micro motor 180 may rotate locking blade rotating screw 178 to move sliding locking blade 186 into a locked position. FIG. 1H is a cutaway view of an example of lock 104 wherein plug 182 is disposed within socket 184 and mated to power terminals 174. Sliding locking blade 186 is in a locked position. Plug 182 may be secured within socket 184 by blade 186.

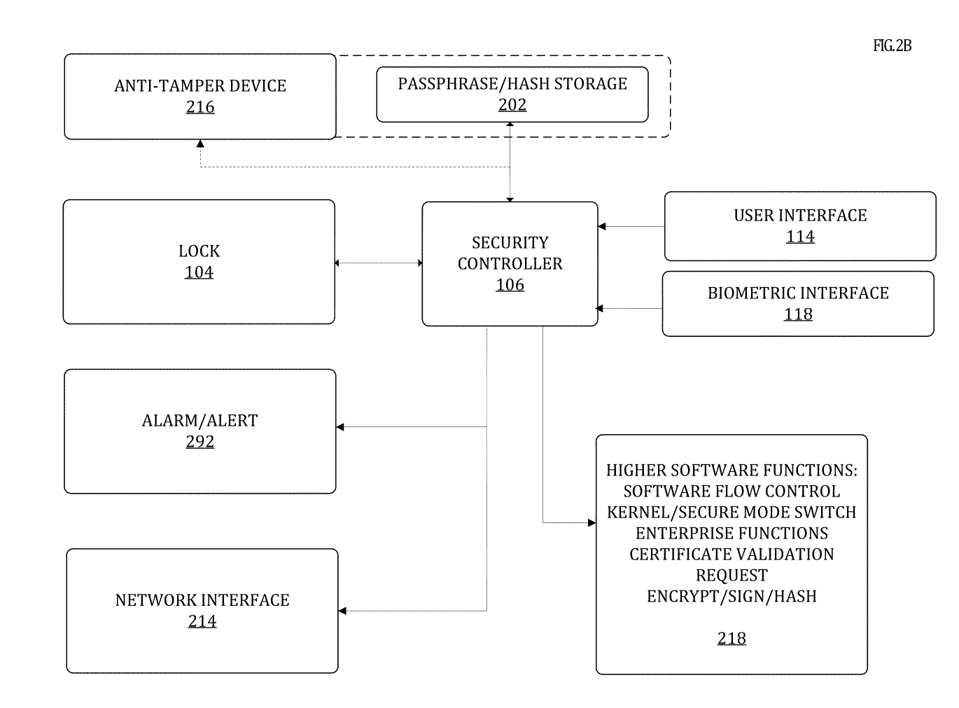

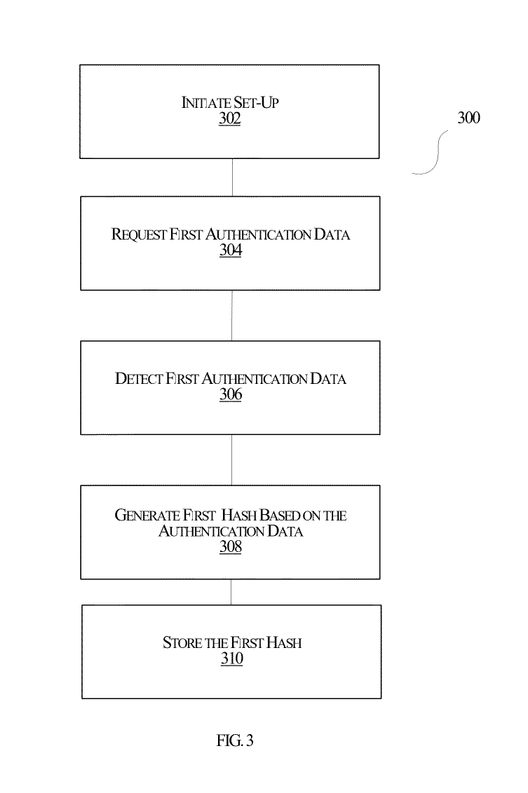

FIG. 2A is a block diagram illustrating an example of system 100 configured to secure and/or release a lock 104 to secure computing device 102. System 100 may comprise computing device 102 including security controller 106, lock 104, interface 114, biometric interface 118 for example a sensor, display 116 and a database 260. Security controller 106 may include memory 202, comparator 206, hash sequence generator 208, and/or counter 210.

In an example, security controller 106 may initiate a security set-up procedure to generate a first hash sequence to be used for authenticating a user. Security controller 106 may control display 116 causing it to display a GUI configured to prompt the user to enter first authentication data via interface 114 and/or biometric interface 118. Hash sequence generator 208 in security controller 106 may generate a first hash sequence based on the first authentication data and may store the first hash sequence in memory 202. Memory 202 may be any of a variety of volatile and/or non-volatile memory types, such as flash memory. In an example, memory 202 may be a remote memory on a secure server. In an example, security controller 106 may initiate a security procedure subsequent to the set-up procedure on computing device 102 responsive to an activation event. During the security procedure, security controller 106 may again generate a GUI on display 116 prompting input of second authentication data. Hash sequence generator 208 may generate a second hash sequence based on the second authentication data entered during the security procedure. Comparator 206 may be configured to compare the first hash sequence and the second hash sequence. If the first hash sequence and second has code match, security controller 106 may be configured to send a command to lock 104 to release lock 104 by electronically controlled physical means and/or virtually by deactivating a virtual lock. Counter 210 may count unsuccessful authentication attempts. Security controller 106 may be configured to reset counter 210 to zero upon successful authentication and release of lock 104.

In an example, security controller may be configured to send a signal and/or message to a remote terminal 212 indicating a status of computing device 102, such as, noting a legitimate release of computing device 102, noting unsuccessful attempts to release lock 104, identifying a location of computing device 102 when coupled to lock 104 and/or detected by wireless sensor 112. Remote terminal 212 may be a site security administration terminal or server. Communications with remote terminal 212 may be conducted via one or more wireline and/or wireless communication channels through a network such as an enterprise network, local area network (LAN) and/or the Internet, or the like or combinations thereof. Security controller 106 may return computing device 102 to a state computing device 102 was in prior to initiating the security procedure.

In an example, if the first hash sequence and second hash sequence do not match, security controller 106 may be configured to increment counter 210 to record the unsuccessful attempt to authenticate and release lock 104. In an example, if counter 210 reaches a threshold value of unsuccessful tries, security controller 106 may be configured to execute one or more enhanced security actions. Such enhanced security actions may be to send a command to a central processing unit (CPU) 220 of computing device 102 to disable some or substantially all functionality of computing device 102, sound an alarm on computing device 102 or elsewhere, report a security breach to authorities and/or a system administrator, upload back-up data from computing device 102 to a remote database 260, and/or the like or a combination thereof. Communication of such enhanced security action commands may be via one or more wireless and/or wireline communication channel(s).

In an example, interface 114 may be secure and may comprise any of a variety of input interfaces such as a keyboard, a mouse, a touchscreen, a touchpad, a wireless sensor, a GUI, and/or the like or a combination thereof. Computing device 102 may generate a password, a passphrase, and/or a passcode in association with an input via interface 114. Such inputs may comprise one or more keystrokes, a wireless sensor reading, a specific pattern drawn on a touchscreen and/or touchpad, or the like or a combination thereof. Biometric interface 118 may comprise a sensor and may measure physical phenomena related to a user such as a thermal pattern, motion, touch, chemical signature, voice, fingerprint, image, eye retina scanning, DNA sampling and/or the like or a combination thereof. Computing device 102 may generate biometric data based on the measured physical phenomena. The first authentication data and the second authentication data may comprise a password, a passphrase, a passcode and/or biometric data, or the like or a combination thereof.

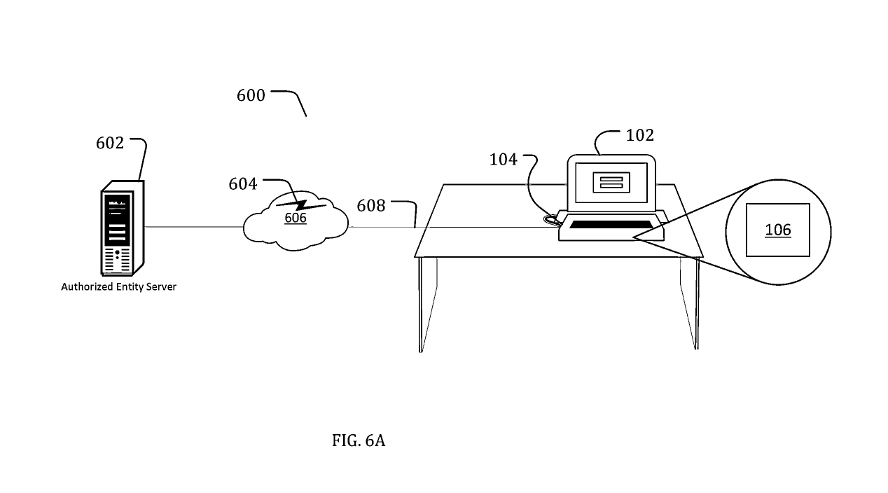

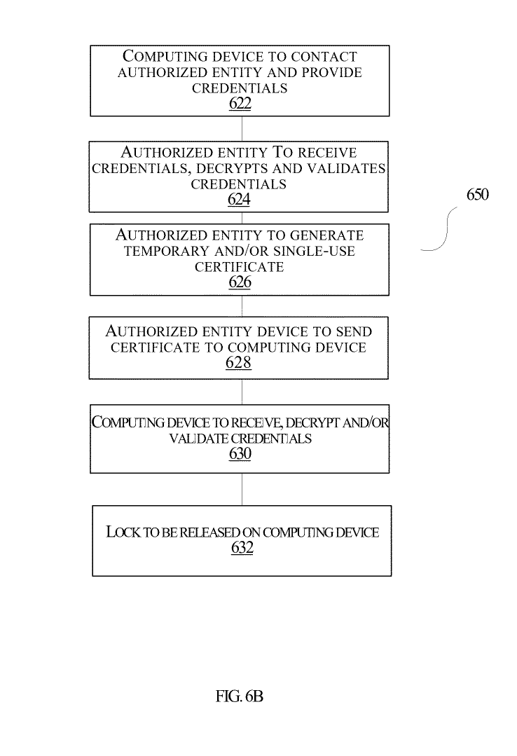

FIG. 2B is a functional diagram illustrating an example of system 100 configured to secure and/or release lock 104 to secure computing device 102. In an example, security controller 106 may communicate with lock 104, an alarm/alert device 292 or software 218, a network interface 214, interface 114, for example, a secure user interface, biometric interface 118, an anti-tamper device 216, and/or may communicate with higher software functions 218 which may enable certain functions in system 100. Higher software functions may include: software flow control, kernel/Secure mode switching, enterprise functions (see FIGS. 6A and 6B, for example), and/or certificate validation request. Security controller 106 may be embodied in security hardware and/or firmware IP.

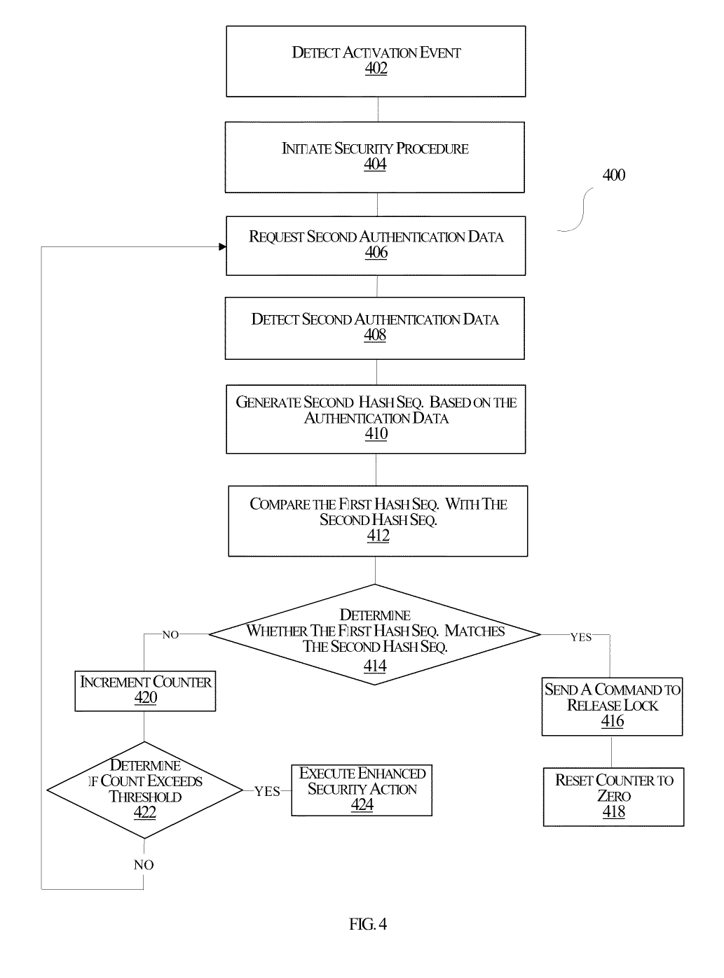

FIG. 3 illustrates an example process 300 for security controller 106 to generate and store authentication data to secure computing device 102. At operation 302, security controller 106 may initiate a set-up procedure on a computing device 102. Security controller 106 may enable a secure mode on computing device 102 in order to execute the set-up procedure securely. Such a secure mode may be a BIOS or secure kernel mode, or the like or a combination thereof where only approved and secure software is allowed to run, and user code is prohibited from running. In an example, computing device 102 may enter a secure mode during BIOS programming or after a particular keyboard key and/or combination is pressed. If this happens while an operating system is running, security controller 106 may suspend substantially all software execution and enter a protected mode. Enabling a secure mode and/or protected mode may prevent security breaches during storage of authentication data.

In an example, at operation 304, security controller 106 may request first authentication data from computing device 102. Security controller 106 may be configured to take over interface 114 and/or biometric interface 118 and to trigger a prompt to request the first authentication data such as a display of a GUI on display 116 of computing device 102. In another example, security controller 106 may be configured to trigger a variety of different prompts to request the first authentication data such as a voice prompt, a light emitting diode (LED) and/or a haptic prompt, or the like or a combination thereof. A haptic prompt may cause a vibration of computing device 102 to signal a request for the first authentication data.

In an example, at operation 306, security controller 106 may detect an input comprising the first authentication data sent from computing device 102. Such an input may be enter via interface 114 and/or biometric interface 118. The input may comprise a passphrase, a passcode, a password and/or biometric data, or the like or a combination thereof. The first authentication data may be read twice and/or otherwise verified. The strength of the first authentication data may be checked. If the first authentication data is not strong enough, different authentication data may be requested until the first authentication data is determined to be strong enough.

In an example, old authentication data may already exists in memory 202. Security controller 106 may request entry of the old authentication data before proceeding with process 300.

In an example, at operation 308, security controller 106 may compute a first hash sequence based on the first authentication data. At operation 310, security controller 106 may store the hash sequence in memory 202. In an example, security controller 106 may store the hash sequence in association with user identification wherein users may also be associated with varying levels of access rights such as administrator rights. Security controller 106 may store multiple hash sequences and/or other authentication data.

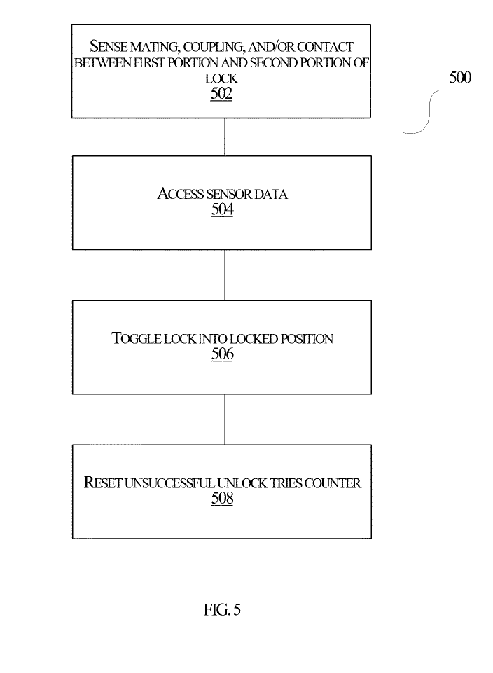

FIG. 4 illustrates an example process 400 to secure and/or release a lock 104 coupled to a computing device 102. At operation 402, security controller 106 may detect an activation event originating with computing device 102. In an example, the activation event may be configured to invoke a security procedure to release lock 104 securing computing device 102. As noted above, the activation event triggering the security procedure may comprise an authentication request, turning on the computing device, a request for secure access to the computing device, sensing an attempt to release lock 104, a unique button press, a key press, a key combination, wireless sensor 112 detecting the computing device within a particular area, and/or the like or a combination thereof.

In an example security controller 106 may periodically and or continuously sample computing device 102 to identify the activation event. Security controller 106 may be always on and always running, in standby mode, and/or continuously sampling the keyboard or other components of computing device 102 to detect an activation event. Security controller 106 may continuously monitor other functions such as anti-tamper devices as well. This may be done in the background continuously or at intervals, for example, if the lock 104 is in a locked position during normal computing device operation or while the computing device is in idle or sleep, or even while it is off. Alternatively, a special button may be provided to wake the security controller 106 from a power-off mode to reduce or eliminate a need to have the security controller 106 running in the background. An anti-tamper device may always be running/ready in the background. Security controller 106 may sample anti-tamper devices at intervals or also react on an interrupt. In an example, the activation event may cause a hardware or software interrupt. Security controller 106 may initiate the security procedure responsive to the hardware or software interrupt. In an example, the hardware or software interrupt may be triggered by an anti-tamper detection event, sensor detection, threshold crossing or other sensor event, and/or the like or a combination thereof. In an example, a security controller 106 may react to and/or wakeup as a response to a hardware and/or software interrupt.

In an example, at operation 404, security controller 106 may initiate a security procedure on computing device 102 responsive to detecting the activation event. Security controller 106 may enable a secure mode on computing device 102 in order to execute the security procedure securely. Such a secure mode may be a BIOS or secure kernel mode, or the like or a combination thereof. In an example, when the secure mode is enabled on computing device 102, security controller 106 may suspend user code execution. Suspension of user code execution may prevent sniffers/malicious code from reading the authentication data from interface 114 and/or biometric interface 118. If computing device 102 was in sleep/idle/off before initiation of the security procedure, computing device 102 may be taken to a minimal state which allows a screen display and operation of interface 114 and/or biometric interface 118.

In an example, at operation 406, security controller 106 may request second authentication data. Security controller 106 may be configured to initiate a prompt to request the second authentication data. Such a prompt may comprise a display of a GUI on display 116. In another example, security controller 106 may be configured to initiate a variety of different user prompts to request the second authentication data such as a voice prompt and/or a haptic prompt, or the like or a combination thereof. A haptic prompt may be configured to cause a vibration of computing device 102 to signal a request for the second authentication data.

In an example, at operation 408, security controller 106 may detect an input comprising the second authentication data. The input may comprise a passphrase, a password, a passcode and/or biometric data, or the like or a combination thereof. The input may be made via interface 114 and/or biometric interface 118. In an example, security controller 106 may directly sense an input to interface 114 and/or biometric interface 118. Such direct sensing may be via direct access, not via a main software path.

In an example, at operation 410, hash sequence generator 208 may compute a second hash sequence based on the second authentication data. At operation 412, comparator 206 may compare the first hash sequence with the second has code. At operation 414, security controller 106 may determine whether the first hash sequence and the second has code match. If the first hash sequence and the second has code match, then process 400 proceeds to operation 416 where security controller 106 sends a command to lock 104 to release lock 104. At operation 418, security controller 106 may reset the counter 210 to zero.

In an example, if the first hash sequence and the second has code do not match, then process 400 proceeds to operation 420 where security controller 106 increments counter 210 and lock 104 remains secured. At operation 422, security controller 106 determines whether the count recorded in counter 210 exceeds a threshold value. A threshold value may be configured in the BIOS for example or optionally while the first authentication data is stored. If the count recorded in counter 210 exceeds a threshold value, then process 400 proceeds to operation 424 where security controller 106 may execute an enhanced security action such as disabling computing device 102, informing remote terminal 212 of illegitimate attempts to unlock computing device 102, informing user of illegitimate attempts to unlock computing device 102, requesting administrator authentication data to release lock and/or sounding an alarm, or the like or a combination thereof. If the count recorded in counter 210 does not exceed a threshold value then process 400 goes back to operation 406 where security controller 106 may again request second authentication data.

FIG. 5 illustrates an example of a process 500 to secure lock 104 on a computing device 102. At operation 502, sensor 140 may sense mating, contact and/or coupling of first portion 122 of lock 104 with second portion 124 of lock 104. Sensor 140 may comprise any of a variety of sensors such as, a touch sensor, a light sensor, a current sensor, a thermal sensor, a pressure sensor and/or the like, or a combination thereon. Sensor 140 may be coupled to lock 104 and/or security controller 106. At operation 504, security controller 106 may access sensor data for example via an interface with lock 104. At operation 506, security controller 106 may toggle lock 104 into a locked position responsive to sensor data. Toggling may be automatic and/or immediate. In an example, a mechanical override option may be provided on computing device 102. In another example, insertion of computing device 102 into a cradle, docking station or plug may be sensed and lock 104 may be automatically engaged responsive to the sensed insertion.

At operation 508, security controller 106 may reset the unlock tries counter 210. In an example, security controller may send a notification that computing device 102 is locked to the operating system and/or to remote terminal 212.

FIG. 6A illustrates an example system 600 to remotely secure and/or release lock 104 on computing device 102. In an example, security controller 106 and/or computing device 102 may be communicatively coupled to a server 602. Server 602 may be authorized to manage security controller 106 and/or computing device 102. Server 602 may belong to any of a variety of authorized entities such as a certification authority, a service center, a network administrator, an authorized peer and/or a system administrator, or the like or a combination thereof. Server 602 may be configured to communicate one or more commands, credentials, passcodes, keys, certificates and/or other authorization data, or the like or a combination thereof to security controller 106. Security controller 106 may be configured to recognize such authorization data and/or may execute commands received from and/or on behalf of server 602. Security controller 106 and server 602 may communicate over wireless 604 and/or wired 608 communication lines. Security controller 106 and server 602 may communicate within a network 606 such as a wide area network (WAN), local area network (LAN), enterprise network, and/or the Internet. In an example, server 602 may enable remote release and/or securing of lock 104. A network administrator may send a command via server 602 and/or credentials authorizing remotely initiate locking and/or unlocking for individual devices in network 606 to lock/unlock computing device 102. Network administrator may send multiple commands to security controllers on other device in network 606 via server 602 to initiate locking and/or unlocking for two or more computing devices in a network 606. Sever 602 may additionally request and/or receive data related to a status and/or location of lock 104 and/or computing device 102 in network 606.

FIG. 6B illustrates an example process 650 to remotely release lock 104 and/or secure authentication data reset. In an example, security controller 106 may be implemented in an SoC or a PCH. Such implementation may enable security controller 106 to directly and securely access various security features of the SoC and/or PCH such as an encryption engine and/or the Central Processing Unit Identification (CPUID). Security controller 106, may be configured to enable secure remote lock release or securing and/or passphrase reset by an authorized entity such as a server 602, certification authority, a service center and/or a system administrator, or the like or a combination thereof.

In an example, if a user forgets their passphrase/key or security controller 106 determines a threshold number of unsuccessful authentication attempts have been made at computing device 102, computing device 102 may be inaccessible. In such an event, the authorized entity device may release lock 104 remotely.

In an example, at operation 622, user device which may be computing device 102, may contact and/or send a message to the authorized entity and provide credentials such as, encrypted and/or time-stamped and/or playback protected information which may include a proof of purchase, the CPU_ID and/or a service fee, or the like or a combination thereof. In an example, such a credential exchange may be executed with provisions to protect against man-in-the-middle attacks.

At operation 624, the authorized entity may receive credentials, decrypt and/or validate the credentials. Upon validation the authorized entity may increase the level of security by directly contacting the user for additional identifying details or accept the credentials presented and/or release lock 104 and/or enable the user to reset their authentication data.

At operation 626, the authorized entity may generate a temporary and/or single-use certificate which may include a key release passphrase and/or key reset command. The key release passphrase and/or key reset command may be based on information relayed by the user and/or additional information. The additional information may be stored in a hash sequence form in an authorized entity database and/or on security controller 106.

At operation 628, the authorized entity may send the certificate to computing device 102. The certificate may be encrypted. Alternatively, the authorized entity may deem the user credentials inadequate and/or may not send a release certificate to computing device 102 and may document and/or report the attempt to illegitimate attempt to remotely unlock computing device 102.

At operation 630, upon receipt of the certificate at computing device 102, security controller 106 may decrypt and/or validate the certificate. In an example, the certificate may be limited to be operational during a specified period of time from its generation and may be for a single use. If the certificate is invalid, security controller 106 may record and/or report a failed attempt to unlock lock 104 using remote authentication.

At operation 632, lock 104 may be released by security controller 106 responsive to decryption and/or validation of the certificate.

Release of lock 104 may be prevented if the certificate did not arrive within a specified time window. Further, release of lock 104 may be prevented if the certificate was previously used. Previous use of the certificate and/or expiration of the specified time window may cause validation of the certificate to fail. Thus, remote release of lock 104 may be prevented. This method may provide protection against recording and/or retransmission of release certificates. Additional means of time synchronization between the computing device 102 and the authorized entity server and additional credentials required by the customer may be embedded in the architecture of security controller 106.

The system and apparatus described above may use dedicated processor systems, micro controllers, programmable logic devices, microprocessors, or the like, or any combination thereof, to perform some or all of the operations described herein. Some of the operations described above may be implemented in software and other operations may be implemented in hardware. One or more of the operations, processes, and/or methods described herein may be performed by an apparatus, a device, and/or a system substantially similar to those as described herein and with reference to the illustrated figures.

In an example, security controller 106 and/or CPU 220 may execute instructions or “code” stored in memory. The memory may store data as well. In an example, security controller 106 and/or CPU 220 may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless and/or wireline transmission.

In an example, security controller 106 and/or CPU 220 memory may be integrated together with the processing device, for example RAM, ROM or FLASH memory disposed within an integrated circuit microprocessor or the like. In other examples, the memory may comprise an independent device, such as an external disk drive, a storage array, a portable FLASH key fob, or the like. The memory and security controller 106 and/or CPU 220 may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a conventional rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or the like, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

Operating instructions or commands disclosed above may be implemented or embodied in logic and/or in a state machine, implemented, for example, in Verilog or VHDL code or other code or an analog computer. Some of anti-tamper devices may have analog computing in a narrow sense in order to conserve battery power. State machine implementation may be more rigid and secure and resemble logic functions but less flexible or extendable. A state machine implementation may be more secure because it may be more difficult to interrupt and/or interfere with a state machine compared to a micro-processor, for example. In an example, a state machine implementation may be provided alongside a CPU in logic gates within an IC, in PCH in logic gates of the IC and/or as a stand-alone field-programmable gate array (FPGA) and/or a complex programmable logic device (CPLD) based state machine implementation, or the like or a combination thereof.

Disclosed herein is a computing device comprising, a processor and a memory device coupled to the processor wherein the processor is configured to initiate a security procedure to control a lock securing the computing device responsive to an action invoking the security procedure, enable a secure computing mode on the computing device responsive to initiation of the security procedure, verify authentication data associated with the computing device and a user and control lock and/or release of the lock responsive to verification of the authentication data. The computing device may be a tablet, an Ultrabook® system, a mobile phone, a laptop computer and/or a desktop computer. The computing device may be configured such that the action invoking the security procedure comprises a start-up command, a unique button press, key press, a key combination, and/or a sensor signal. The computing device may be configured such that the authentication data comprises biometric data. The computing device may be configured such that the processor is further configured to output a user interface to request the authentication data, wherein the user interface is configured to prompt a passphrase, a passcode, a password entry and/or a biometric data entry. The computing device may be configured such that the user interface is a graphical user interface (GUI), an voice prompt, a haptic prompt, or a light emitting diode (LED), or a combination thereof. The computing device may be configured such that control of the lock is electronically regulated.

Disclosed herein is a method to secure a computing device comprising invoking, by a security controller, a security procedure to control a lock coupled to the computing device responsive to detecting an activation event, enabling, by the security controller, a secure computing mode on the computing device, verifying, by the security controller, authentication data and sending, by the security controller, a command to control the lock responsive to verification of the authentication data. The method for verifying the authentication data may further comprise storing, by the security controller, a first hash sequence, detecting, by the security controller, the authentication data, generating, by the security controller, a second hash sequence based on the authentication data, comparing, by the security controller, the second hash sequence to the first hash sequence, determining, by the security controller, whether the first hash sequence matches the second hash sequence, sending, by the security controller, a command to the lock to release the lock if the first hash sequence matches the second hash sequence, else, incrementing, by the security controller, an counter value if the first hash sequence does not match the second hash sequence. The method may further include determining, by the security controller, whether the counter value is greater than a threshold value, requesting, by the security controller, the authentication data again, if the value does not exceed the threshold value and terminating, by the security controller, the security procedure if the counter value exceeds the threshold value. The method may be configured such that the command is configured to trigger release of an electronic latch securing the lock. The activation event in the method may comprise turning on the computing device, sending a request for secure access to the computing device, sensing an attempt to release the lock, a unique button press, a key press, a key combination and detecting the computing device within a particular area.

Disclosed herein is a non-transitory computer-readable medium comprising instructions that, in response to execution of the instructions by a processor, enables the processor to initiate a security procedure to control a lock securing a computing device responsive to an activation event, enable a secure computing mode on the computing device, request authentication data in the secure computing mode, verify the authentication data, and send a command to control the lock responsive to verification of the authentication data. The non-transitory computer-readable medium may be configured such that the lock is a virtual lock, wherein the virtual lock is configured to sense a presence of the computing device within a particular area, and activate an alarm when the computing device is removed from the particular area. The non-transitory computer-readable medium may be configured such that the execution of the instructions further enables the processor to detect the activation event by intermittent or continuous sampling of an interface of the computing device. The non-transitory computer-readable medium may be configured such that the activation event may cause a hardware or software interrupt wherein the initiating the security procedure is responsive to the hardware or software interrupt. The non-transitory computer-readable medium may be configured such that the hardware or software interrupt is triggered by an anti-tamper detection event, sensor detection, threshold crossing or a combination thereof. The non-transitory computer-readable medium may be configured such that execution of the instructions further enables the processor to suspend user code execution responsive to enabling the secure mode. The non-transitory computer-readable medium may be configured such that the secure mode is a BIOS mode or secure kernel mode.

Disclosed herein is a system to release an electronic lock securing a computing device comprising means for initiating the security procedure to be executed in a secure mode responsive to an activation event, means for requesting authentication data in the secure mode, means for verifying the authentication data, and means for controlling the electronic lock responsive to verification of the authentication data. The system may be configured such that the means for controlling the electronic lock are remote. The system may be configured such that the means for verifying the authentication data further comprises means for sending a request and credentials to a remote authorized entity to release the electronic lock and/or reset authentication data after reaching a threshold number of attempts to release the lock, means for receiving a certificate from the authorized entity responsive to authentication of the credentials, and means for decrypting and/or validating the certificate. The system may further comprise means for detecting the activation event, and means for enabling a secure computing mode on the computing device responsive to the activation event.

Disclosed herein is a state machine comprising a logic circuit configured to initiate a security procedure to control a lock securing the computing device responsive to an action invoking the security procedure, enable a secure computing mode on the computing device responsive to initiation of the security procedure, identify authentication data associated with the computing device and a user, verify the authentication data, send a command to control the lock responsive to verification of the authentication data, and activate the lock responsive to the command. The state machine may be configured such that the computing device is a tablet, an Ultrabook® system, a mobile phone, a laptop computer and/or a desktop computer. The state machine may be configured such that the action invoking the security procedure comprises a start-up command, a unique button press, key press, a key combination, and/or a sensor signal. The state machine may be configured such that the logic is further configured to output a user interface to request the authentication data, wherein the user interface is configured to prompt a passphrase, a passcode, a password entry and/or a biometric data entry. The state machine may be configured such that when the logic activates the lock, the logic is further configured to electronically secure and/or release the lock.

Disclosed herein is machine-readable storage including machine-readable instructions, when executed, to implement a method or realize an apparatus as described herein.

Having described and illustrated the principles of examples, it should be apparent that the examples may be modified in arrangement and detail without departing from such principles. We claim all modifications and variation coming within the spirit and scope of the following claims.

We claim:

1. A computing device comprising:
a processor and a memory device coupled to the processor, the processor configured to:
initiate a security procedure to control a lock securing a computing device responsive to an action invoking the security procedure;
enable a secure computing mode on the computing device responsive to initiation of the security procedure;
verify authentication data associated with the computing device and a user; and
control lock and/or release of the lock responsive to verification of the authentication data.

2. The computing device of claim 1, wherein the computing device is a tablet, an Ultrabook® system, a mobile phone, a laptop computer and/or a desktop computer.

3. The computing device of claim 1, wherein the action invoking the security procedure comprises a start-up command, a unique button press, key press, a key combination, and/or a sensor signal.

4. The computing device of claim 1, wherein the authentication data comprises biometric data.

5. The computing device of claim 1, wherein the processor is further configured to output a user interface to request the authentication data, wherein the user interface is configured to prompt a passphrase, a passcode, a password entry and/or a biometric data entry.

6. The computing device of claim 5, wherein the user interface is a graphical user interface (GUI), an voice prompt, a haptic prompt, or a light emitting diode (LED), or a combination thereof.

7. The computing device of claim 1, wherein control of the lock is electronically regulated.

8. A method to secure a computing device comprising:
invoking, by a security controller, a security procedure to control a lock coupled to the computing device responsive to detecting an activation event;
enabling, by the security controller, a secure computing mode on the computing device;
verifying, by the security controller, authentication data; and
sending, by the security controller, a command to control the lock responsive to verification of the authentication data.

9. The method of claim 8, wherein verifying the authentication data further comprises:
storing, by the security controller, a first hash sequence;
detecting, by the security controller, the authentication data;
generating, by the security controller, a second hash sequence based on the authentication data;
comparing, by the security controller, the second hash sequence to the first hash sequence;
determining, by the security controller, whether the first hash sequence matches the second hash sequence;
sending, by the security controller, a command to the lock to release the lock if the first hash sequence matches the second hash sequence; and
else, incrementing, by the security controller, a counter value if the first hash sequence does not match the second hash sequence.

10. The method of claim 9, further comprising:
determining, by the security controller, whether the counter value is greater than a threshold value;
requesting, by the security controller, the authentication data again, if the value does not exceed the threshold value; and
terminating, by the security controller, the security procedure if the counter value exceeds the threshold value.

11. The method of claim 8, wherein the command is configured to trigger release of an electronic latch securing the lock.

12. The method of claim 8, wherein the activation event invoking the security procedure is at least one of: turning on the computing device, sending a request for secure access to the computing device, sensing an attempt to release the lock, a unique button press, a key press, a key combination and detecting the computing device within a particular area.

13. A non-transitory computer-readable medium comprising instructions that, in response to execution of the instructions by a processor, enables the processor to:
initiate a security procedure to control a lock securing a computing device responsive to an activation event;
enable a secure computing mode on the computing device;
request authentication data in the secure computing mode;
verify the authentication data; and
send a command to control the lock responsive to verification of the authentication data.

14. The non-transitory computer-readable medium of claim 13, wherein the lock is a virtual lock, wherein the virtual lock is configured to:
sense a presence of the computing device within a particular area; and
activate an alarm when the computing device is removed from the particular area.

15. The non-transitory computer-readable medium of claim 13, wherein execution of the instructions further enables the processor to detect the activation event by intermittent or continuous sampling of an interface of the computing device.

16. The non-transitory computer-readable medium of claim 13, wherein the activation event causes a hardware or software interrupt and wherein the initiating the security procedure is responsive to the hardware or software interrupt.

17. The non-transitory computer-readable medium of claim 16, wherein the hardware or software interrupt is triggered by an anti-tamper detection event, sensor detection, threshold crossing or a combination thereof.

18. The non-transitory computer-readable medium of claim 13, wherein execution of the instructions further enables the processor to suspend user code execution responsive to enabling the secure computing mode.

19. The non-transitory computer-readable medium of claim 13, wherein the secure computing mode is a BIOS mode or secure kernel mode.

20. A system to release an electronic lock securing a computing device comprising:
means for initiating the security procedure to be executed in a secure mode responsive to an activation event;
means for requesting authentication data in the secure mode;
means for verifying the authentication data; and
means for controlling the electronic lock responsive to verification of the authentication data.

21. The system of claim 20 wherein the means for controlling the electronic lock are remote.

22. The system of claim 20 wherein the means for verifying the authentication data further comprises:
means for sending a request and credentials to a remote authorized entity to release the electronic lock and/or reset the authentication data after reaching a threshold number of attempts to release the lock;
means for receiving a certificate from the authorized entity responsive to authentication of the credentials; and
means for decrypting and/or validating the certificate.

23. The system of claim 20 further comprising:
means for detecting the activation event; and
means for enabling a secure computing mode on the computing device responsive to the activation event.

24. A state machine comprising:
a logic circuit configured to;
initiate a security procedure to control a lock securing a computing device responsive to an action invoking the security procedure;
enable a secure computing mode on the computing device responsive to initiation of the security procedure;
identify authentication data associated with the computing device and a user;
verify the authentication data;
send a command to control the lock responsive to verification of the authentication data; and
activate the lock responsive to the command.

25. The state machine of claim 24, wherein the computing device is a tablet, an Ultrabook® system, a mobile phone, a laptop computer and/or a desktop computer.

26. The state machine of claim 24, wherein the action invoking the security procedure comprises a start-up command, a unique button press, key press, a key combination, and/or a sensor signal.

27. The state machine of claim 24, wherein the logic is further configured to output a user interface to request the authentication data, wherein the user interface is configured to prompt a passphrase, a passcode, a password entry and/or a biometric data entry.

28. The state machine of claim 24, wherein when the logic activates the lock, the logic is further configured to electronically secure and/or release the lock.
